(19) United States
(12) Patent Application Publication
(10) Pub. No.: US 2022/0063199 A1
(43) Pub. Date: Mar. 3, 2022

(54) ARTIFICIAL INTELLIGENCE IN ADDITIVE MANUFACTURING AND RELATED SYSTEMS, METHODS, AND DEVICES

(71) Applicant: Baker Hughes Oilfield Operations LLC, Houston, TX (US)

(72) Inventors: Jayesh Rameshlal Jain, The Woodlands, TX (US); Mackenzie Dreese, Oklahoma City, OK (US); Lakshmi Jyotshna Vendra, Spring, TX (US); Mikhail Nikolaevich Gladkikh, Conroe, TX (US); Thomas Dobrowolski, The Woodlands, TX (US)

(21) Appl. No.: 17/003,710

(22) Filed: Aug. 26, 2020

(51) Int. Cl. B29C 64/393; B29C 64/141; B33Y 30/00; B33Y 50/02

(52) U.S. Cl. CPC B29C 64/393; B33Y 50/02; B33Y 30/00; B29C 64/141

(57) ABSTRACT

Additive manufacturing systems and related systems, methods, and devices are disclosed. An additive manufacturing system includes an additive manufacturing apparatus configured to manufacture an object using additive manufacturing. The additive manufacturing system also includes control circuitry configured to correlate input factors related to manufacturing of the object to manufacturing outcomes.

### FIELD

The present disclosure relates generally to the use of machine learning and artificial intelligence in additive manufacturing processes, and more specifically to the use of machine learning and artificial intelligence to identify and exploit relationships between input parameters and manufacturing outcomes in additive manufacturing processes.

### BACKGROUND

Additive Manufacturing is a new, rapidly growing industry, which employs a variety of manufacturing methods that manufacture workpieces layer-by-layer, in contrast with common subtractive manufacturing techniques that create the desired workpiece by removing material from bar stock. Additive manufacturing uses feedstock material in the form of powder, wire, filament, or slurry, and works with a variety of materials such as metals, plastics, and ceramics.

### BRIEF SUMMARY

In some embodiments an additive manufacturing system includes an additive manufacturing apparatus. The additive manufacturing apparatus includes a material feed configured to receive feedstock material to be used in additive manufacturing of an object. The additive manufacturing system also includes an X-ray system configured to monitor the feedstock material as the feedstock material is fed into the material feed. The X-ray system is also further configured to provide material data corresponding to the feedstock material. The additive manufacturing system further includes control circuitry configured to extract one or more feedstock properties from the material data, and correlate the one or more feedstock properties with one or more manufacturing outcomes responsive to manufacturing the object.

In some embodiments an additive manufacturing system includes an additive manufacturing apparatus configured to manufacture an object from a feedstock material using additive manufacturing. The additive manufacturing apparatus includes a feedstock material bed configured to carry the feedstock material. The additive manufacturing system also includes one or more illumination sources configured to illuminate the feedstock material carried by the feedstock material bed. Each of the one or more illumination sources is configured to point at the feedstock material carried by the feedstock material bed at a glancing angle with the feedstock material bed of less than sixty degrees. The additive manufacturing system further includes one or more illumination detectors configured to capture an image of the feedstock material responsive to the illumination from the one or more illumination sources. The additive manufacturing system further includes control circuitry operably coupled to the one more illumination detectors. The control circuitry is configured to identify one or more feedstock material properties of the feedstock material based on the captured image, and correlate the one or more feedstock material properties with manufacturing outcomes of the object.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a block diagram of an additive manufacturing system, according to some embodiments;

FIG. 2 is a fishbone diagram illustrating examples of input factors that may be correlated with manufacturing outcomes in additive manufacturing of an object, according to some embodiments;

FIG. 3 is a perspective view of a re-coater assembly, which may be part of a material delivery system of the additive manufacturing system of FIG. 1, according to some embodiments;

FIG. 4 is a cross-sectional view of a powder bed of the re-coater assembly of FIG. 3, according to some embodiments;

FIG. 5 is a block diagram of an additive manufacturing system, which is an example of the additive manufacturing system of FIG. 1, according to some embodiments;

FIG. 6 is a block diagram of control circuitry of the additive manufacturing system of FIG. 1, according to some embodiments;

FIG. 7 is a block diagram of an example of a training engine, which may be used as a training engine of the control circuitry of FIG. 6, according to some embodiments;

FIG. 8 is a flowchart illustrating a method of operating an additive manufacturing system, according to some embodiments;

FIG. 9 is a block diagram of a network-based additive manufacturing system, according to some embodiments; and

FIG. 10 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Additive manufacturing includes various manufacturing methods (modalities) that allow “growing” an object from feedstock (e.g., powder, wire, filament, etc.) layer by layer into a desired shape rather than removing material from bar stock. Advantages of additive manufacturing include relative simplicity of manufacturing and freedom of design (e.g., shape complexity does not matter). As compared to subtractive manufacturing, additive manufacturing is simple because it uses fewer manufacturing steps, most of the process occurs in a single additive manufacturing apparatus, and no operator runs the additive manufacturing apparatus.

Today, due to the novelty of the industry, most of the relationships between desired outcomes (such as mechanical properties of manufactured parts) and input factors (such as feedstock material properties or process parameters) are either unknown or used as “rules of thumb”, being discovered empirically. Accordingly, best-desired outcomes may not be provided in terms of manufactured part quality or the speed and cost of the manufacturing process.

Embodiments disclosed herein relate to a comprehensive framework that is capable of discovering the presence and relative importance of such relationships based on the (1) acquired relevant data; (2) utilization of artificial intelligence algorithms, such as Neural Networks, to discover statistically significant trends and relationships; and (3) continuous improvement with the addition of more relevant data and targeted studies, such as design of experiments. Artificial intelligence (or the subset of machine learning algorithms) is applied to solve many data-driven problems in a variety of industries, including autonomous driving, handwriting recognition, natural language processing, and computer vision (e.g., object or facial recognition), to name a few. Machine learning according to embodiments disclosed herein refers to the scientific study of algorithms and statistical models that computer systems use to effectively perform a specific task without using explicit instructions, relying on patterns and inference instead.

Embodiments disclosed herein are comprehensive in nature of methodology and data aggregation from various sources including feedstock, process, machine, environmental, and mechanical testing data. Embodiments disclosed herein include novel data analytics methodologies including data cleaning, vectorization, screening, filtering, and using artificial intelligence (e.g., neural network algorithms) to provide probabilistic recommendations on statistical significance of input parameters on desired outcomes.

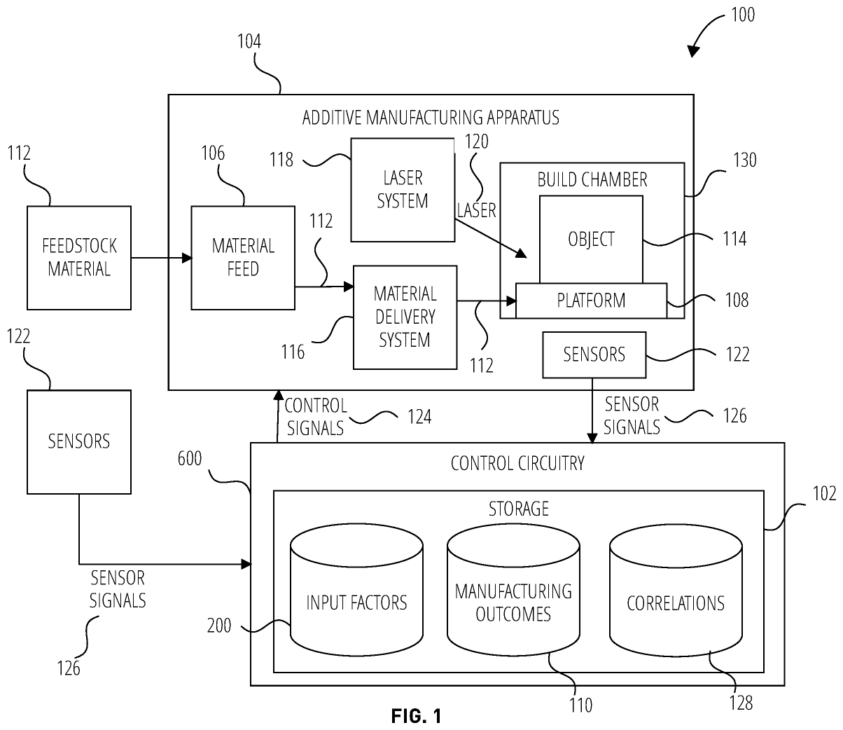

FIG. 1 is a block diagram of an additive manufacturing system 100, according to some embodiments. The additive manufacturing system 100 includes an additive manufacturing apparatus 104 and control circuitry 600 operably coupled to the additive manufacturing apparatus 104. The additive manufacturing apparatus 104 is configured to receive a feedstock material 112 and manufacture an object 114 using the feedstock material 112. The control circuitry 600 is configured to identify statistically significant correlations 128 between input factors 200 and manufacturing outcomes 110 responsive to the manufacture of the object 114. The control circuitry 600 is configured to store the input factors 200, the manufacturing outcomes 110, and the identified correlations 128. The control circuitry 600 is further configured to modify operation of the additive manufacturing apparatus 104 responsive to detections of input factors 200 corresponding to the identified correlations 128 between the input factors 200 and the manufacturing outcomes 110.

The additive manufacturing apparatus 104 includes a material feed 106, a material delivery system 116, a platform 108 in a build chamber 130, and a laser system 118. The material feed 106 is configured to receive the feedstock material 112 to be used in the additive manufacturing of the object 114. In some embodiments the material feed 106 is configured to provide the feedstock material 112 to the material delivery system 116, which in turn is configured to deliver the feedstock material 112 to the platform 108 in the build chamber 130. By way of non-limiting example, in embodiments where the feedstock material includes powder 112, the material delivery system 116 may include a powder handler. In some embodiments the material delivery system 116 is configured to deliver the feedstock material 112 to the material feed 106 in addition to or instead of deliver the feedstock material 112 from the material feed 106 to the platform 108. With the feedstock material 112 delivered to the platform 108, the laser system 118 is configured to use a laser 120 on the feedstock material 112 to form the object 114. The additive manufacturing apparatus 104 is configured to manufacture the object 114 on the platform 108, layer by layer, as the feedstock material 112 is fed to the material feed 106 and delivered to the platform 108 by the material delivery system 116.

The additive manufacturing system 100 may further include sensors 122 (e.g., internal to the additive manufacturing apparatus 104 and/or external to the additive manufacturing apparatus 104). The sensors 122 are configured to monitor some of various input factors 200 and/or manufacturing outcomes 110. The sensors 122 are further configured to generate sensor signals 126 indicating the monitored input factors 200 and/or manufacturing outcomes 110, and provide the sensor signals 126 to the control circuitry 600. The control circuitry 600 is configured to store the input factors 200, the manufacturing outcomes 110 indicated by the sensor signals 126, and/or the correlations 128 in one or more data storage devices (referred to herein as “storage 102”). In some embodiments information leading to the input factors 200 and the manufacturing outcomes 110 may be cleaned (e.g., filtered), characterized, and/or vectorized before it is stored in the storage 102.

The control circuitry 600 may be configured to control at least a portion of operation of the additive manufacturing apparatus 104. The control circuitry 600 may be configured to control the additive manufacturing apparatus 104 using control signals 124 including commands configured to indicate to the additive manufacturing apparatus 104 specifics of operation. By way of non-limiting examples, the control circuitry 600 may be configured to control feeding of the feedstock material 112 into the material feed 106, operation of the material delivery system 116, operation of the laser system 118, operation of the sensors 122, other operations, or combinations thereof.

As previously indicated, some of the input factors 200 and the manufacturing outcomes 110 may be provided to the control circuitry 600 by the sensors 122 via the sensor signals 126. It will be understood, however, that some of the input factors 200 and/or the manufacturing outcomes 110 may be tracked directly by the control circuitry 600 rather than being indicated by the sensor signals 126. For example, some of the input factors 200 may be directly indicated or indirectly implied by commands indicated in the control signals 124, or by processing of the control circuitry 600 used to generate the control signals 124. As a specific, non-limiting example, a power level of the laser 120 may be controlled via the control signals 124, and the control circuitry 600 may store the power level of the laser 120 as one of the input factors 200 in the storage 102.

The control circuitry 600 is further configured to identify specific problems or relationships to investigate. More specifically, the control circuitry 600 is configured to identify statistically significant relationships between the input factors 200 and the manufacturing outcomes 110 and store the identified statistically significant relationships as the correlations 128. By way of non-limiting example, the control circuitry 600 may be configured to identify how particle distribution of a powder form of the feedstock material 112 impacts mechanical properties of the object 114, and what is the statistical significance of such an impact. Artificial intelligence algorithms such as neural networks, logistic regression, or support vector machines may be created, trained, and used over the data (i.e., the input factors 200 and the manufacturing outcomes 110) to provide insights related to identified problems or correlations 128. These artificial intelligence algorithms may be augmented with targeted studies that include specific data acquisition and/or engineered inputs (e.g., particle distribution can be varied according to a specifically designed testing plan).

To the extent that identified statistically significant correlations 128 between input factors 200 and manufacturing outcomes 110 involve input factors 200 that the control circuitry 600 has control over (e.g., via the control signals 124), the control circuitry 600 may be configured to modify operation of the additive manufacturing apparatus 104 based on the identified statistically significant correlations 128. In instances where an identified one of the input factors 200 is determined to have a beneficial effect on the correlated one of the manufacturing outcomes 110, the control circuitry 600 may modify operation of the additive manufacturing apparatus 104 to exploit the beneficial one of the input factors 200. In instances where an identified one of the input factors 200 is determined to have a detrimental effect on the correlated one of the manufacturing outcomes 110, the 102 may take corrective action by modifying operation of the additive manufacturing apparatus 104 to avoid the detrimental one of the input factors 200 and the correlated detrimental effect. By way of non-limiting example, in instances where the control circuitry 600 has identified a statistically significant relationship between a particular condition or property of the feedstock material 112 and an undesirable manufacturing outcome, the control circuitry 600 may control the manufacturing apparatus 104 to discard the at least a portion of the feedstock material 112 that is manifesting the particular condition or property (e.g., a powder handler of the material delivery system 116 may discard powder feedstock material) responsive to the sensors 122 detecting the particular condition or property.

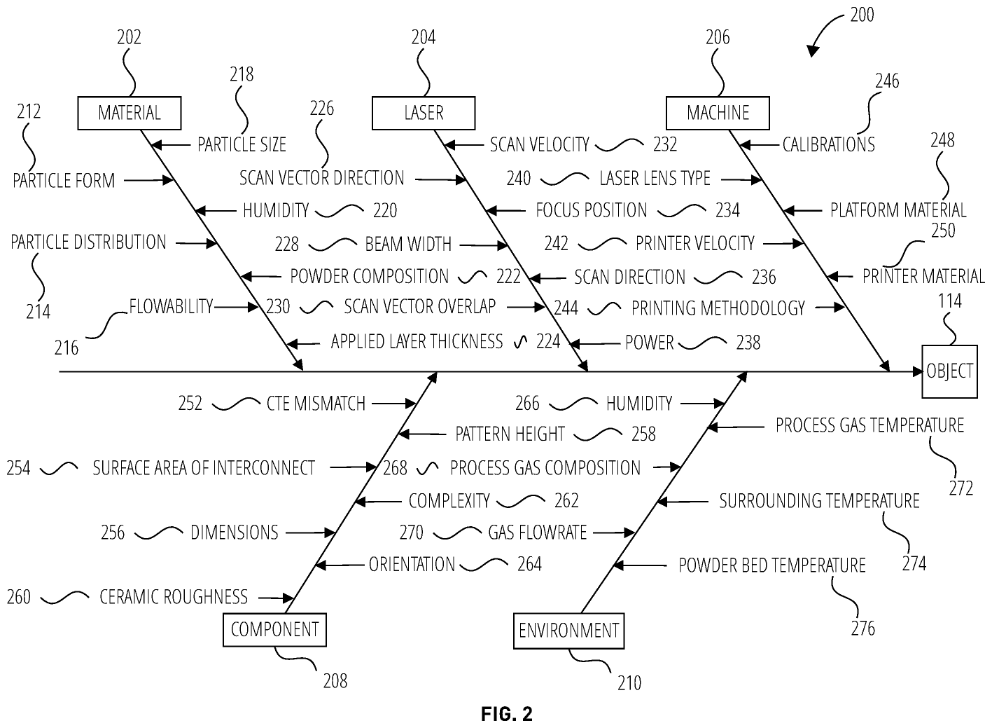

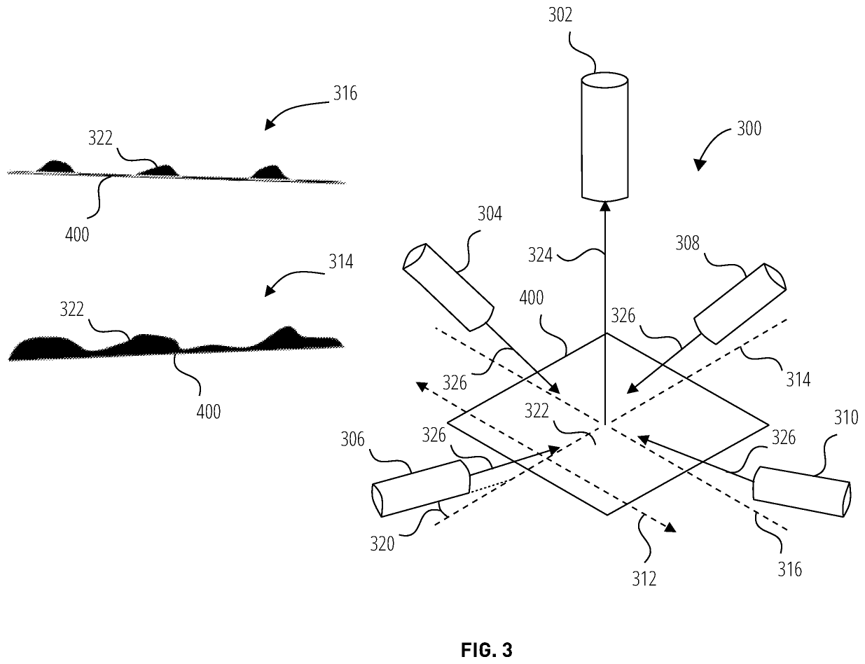

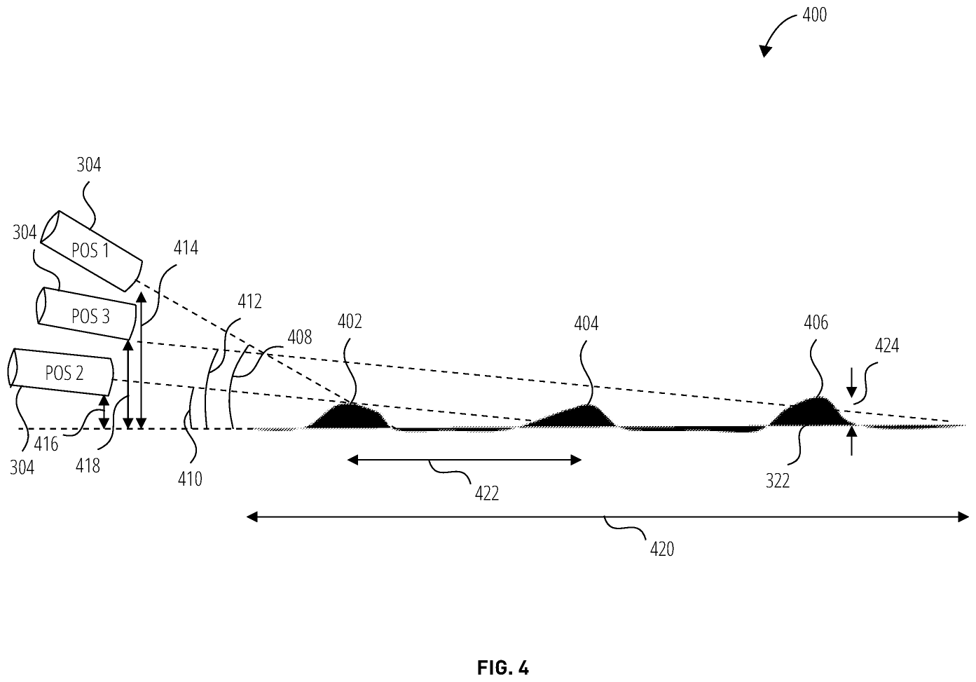

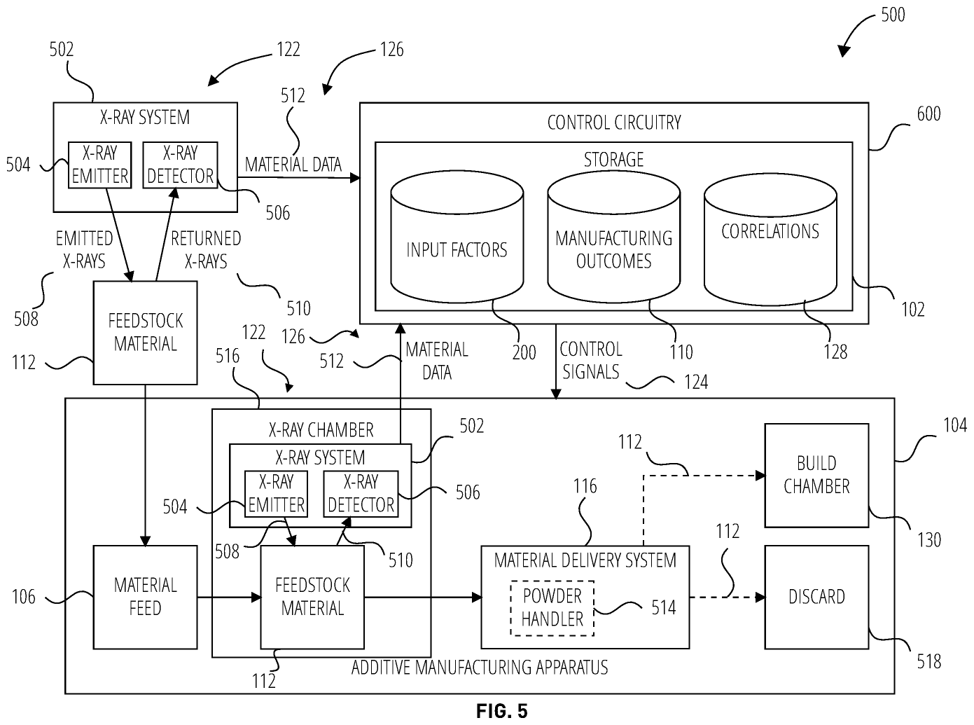

The input factors 200 and the manufacturing outcomes 110 may be any of various different items. Some examples of the input factors 200 are discussed below with reference to FIG. 2. Also, by way of non-limiting example, the input factors 200 may include feedstock material information gathered using one or more cameras (e.g., camera 302 of FIG. 3) and illumination sources configured to illuminate the feedstock material 112 at the material delivery system 116 and/or at the material feed 106, as will be discussed with reference to FIG. 3 and FIG. 4 below. As a further example the input factors 200 may include feedstock information gathered using an X-ray system 502, as will be discussed with reference to FIG. 5 below. The manufacturing outcomes 110 may include, for example, mechanical properties of the object 114, quality of the object 114, manufacturing process speed, cost of manufacturing, other manufacturing outcomes, or combinations thereof.

FIG. 2 is a fishbone diagram illustrating examples of input factors 200 that may be correlated with manufacturing outcomes 110 in additive manufacturing of an object 114, according to some embodiments. The input factors 200 illustrated in FIG. 2 are divided into different categories. The categories include a material category 202, a laser category 204, a machine category 206, a component category 208, and an environment category 210.

The material category 202 includes examples of the input factors 200 that are related to the feedstock material 112 (FIG. 1). For example, the material category 202 may include particle form 212, particle distribution 214, flowability 216, particle size 218, humidity 220, powder composition 222, and applied layer thickness 224, without limitation. The particle form 212 may include information indicating geometry (e.g., shape, surface imperfections, etc.) of particles of feedstock material 112 (FIG. 1), assuming that the feedstock material 112 is a particle feedstock material. It should be noted that the input factors 200 may include wire, filament, or slurry form instead of or in addition to particle form 212 where wire, filament, or slurry forms of the feedstock material 112 are used instead of or in addition to particle forms of the feedstock material 112. The particle distribution 214 may include information indicating how particles are distributed (e.g., as they enter the material feed 106 (FIG. 1), at the material delivery system 116, on the platform 108, or combinations thereof). It should be noted that the input factors 200 may include wire, filament, or slurry distribution instead of or in addition to particle distribution 214 where wire, filament, or slurry forms of the feedstock material 112 are used instead of or in addition to particle forms of the feedstock material 112. The flowability 216 may include information indicating how flowable the feedstock material 112 is. For example, the flowability 216 may refer to flowability of the feedstock material 112 at the material feed 106, the material delivery system 116, the platform 108, or combinations thereof. The particle size 218 may include information indicating size (e.g., diameter) of particles used as feedstock material 112. It should be noted that the input factors 200 may include wire, filament, or slurry size instead of or in addition to particle size 218 where wire, filament, or slurry forms of the feedstock material 112 are used instead of or in addition to particle forms of the feedstock material 112. The humidity 220 may include information indicating water content of the feedstock material 112. The powder composition 222 may include information indicating composition (e.g., element and/or compound identifying information) of the feedstock material 112. It should be noted that input factors 200 may include wire, filament, or slurry composition instead of or in addition to powder composition 222 where wire, filament, or slurry forms of the feedstock material are used instead of or in addition to powder. The applied layer thickness includes information indicating how thick layers of the feedstock material 112 are when provided to the platform 108 (FIG. 1).

The laser category 204 includes examples of the input factors 200 that are related to the laser 120 (FIG. 1). For example, the laser category 204 may include scan vector direction 226, beam width 228, scan vector overlap 230, scan velocity 232, focus position 234, scan direction 236, and power 238, without limitation. The scan vector direction 226 may include information indicating a direction and/or a length of scan vectors of the laser 120. The beam width 228 may include information indicating a beam width of the laser 120. The scan vector overlap 230 may include information indicating overlap of scan vectors of the laser 120. The scan velocity 232 may include information indicating scan velocity of the laser 120. The focus position 234 may include information indicate a position of a focus of the laser 120. The scan direction 236 may include information indicating a direction of a scan of the laser 120. The power 238 may include information indicating how much power is used to generate the laser 120 and/or how much power is delivered by the laser 120.

The machine category 206 includes examples of the input factors 200 that are related to the additive manufacturing apparatus 104 (FIG. 1). For example, the machine category 206 may include laser lens type 240, printer velocity 242, printing methodology 244, calibrations 246, platform material 248, and printer material 250, without limitation. The laser lens type 240 includes information indicating a type of lens used in conjunction with the laser 120. The printer velocity 242 includes information indicating how fast the additive manufacturing apparatus 104 (FIG. 1) operates (e.g., speed of the material delivery system 116, number of layers added to the object 114 per unit time, etc.). The printing methodology 244 includes information indicating details about the additive manufacturing process (e.g., operational parameters of the additive manufacturing apparatus 104 (FIG. 1)). The calibrations 246 include information indicating details regarding calibrations of the additive manufacturing apparatus 104 (e.g., calibrations of the laser system 118, the sensors 122, etc.). The platform material 248 includes information indicating a material (e.g., elements and/or compounds) of the platform 108 (FIG. 1). The printer material 250 includes information indicating other materials of the additive manufacturing apparatus 104.

The component category 208 includes examples of the input factors 200 that are related to the object 114. For example, the component category 208 includes coefficient of thermal expansion mismatch (CTE mismatch 252), surface area of interconnect 254, dimensions 256, ceramic roughness 258, pattern height 260, complexity 262, and orientation 264, without limitation. The CTE mismatch 252 may include information indicating any mismatches between CTEs of different materials of the object 114. The surface area of interconnect 254 may include information indicating a surface area, of the object 114 that is being manufactured, that is in direct contact with the platform 108 (FIG. 1), a build plate, and/or other support. The dimensions 256 may include information indicating dimensions (e.g., length, width, height, etc.) of the object 114 and or dimensions of sub-portions of the object 114. The ceramic roughness 258 may include information indicating a ceramic roughness of surfaces of the object 114. The pattern height 260 may include information indicating a thickness of a layer of the feedstock material 112 (FIG. 1). The complexity 262 may include information indicating how complex the object 114 is. The orientation 264 may include information indicating an orientation of the object 114 (e.g., an orientation of the object 114 as it is manufactured on the platform 108 (FIG. 1)).

The environment category 210 includes examples of the input factors 200 that are related to the environment. For example, the environment category 210 may include humidity 266, process gas composition 268, gas flowrate 270, process gas temperature 272, surrounding temperature 274, and powder bed temperature 276, without limitation. The humidity 266 may include information indicating a humidity of gas (e.g., air, processing gas, etc.) in the vicinity of the platform 108, the material feed 106, the laser 120, or combinations thereof. The process gas composition 268 may include information indicating a composition of a process gas used while manufacturing the object 114 (e.g., elements and/or compounds). The gas flowrate 270 may include information indicating a flowrate of the process gas used while manufacturing the object 114. The process gas temperature 272 may include information indicating a temperature of a process gas used while manufacturing the object 114. The surrounding temperature 274 may include information indicating a temperature of air in and/or proximate to the additive manufacturing apparatus 104 and/or as a temperature of components of the additive manufacturing apparatus 104. The powder bed temperature 276 includes a temperature of a powder bed that may be used in the material delivery system 116 (e.g., in embodiments where the feedstock material 112 is a powder).

It is noted that the control circuitry 600 (FIG. 1) may be configured to track one or more of the example input factors 200 illustrated in FIG. 2, and other input factors 200 (e.g., spark patterns responsive to burning of feedstock material 112 (FIG. 1) with the laser 120 (FIG. 1), via the sensor signals 126 and/or the control signals 124 (FIG. 1). In addition, the control circuitry 600 may be configured to track the manufacturing outcomes 110 via the sensor signals 126 and/or the control signals 124.

FIG. 3 is a perspective view of a re-coater assembly 300, which may be part of a material delivery system 116 of the additive manufacturing system 100 of FIG. 1, according to some embodiments. The re-coater assembly 300 includes a powder bed 400 configured to carry powder 322 thereon. The powder 322 is an example of the feedstock material 112 of FIG. 1. The powder bed 400 is configured to travel in a re-coater direction of travel 312 to deliver the powder 322 to the platform 108 (FIG. 1). FIG. 3 also illustrates a lateral cross-section 314 and a longitudinal cross-section 316 of the powder bed 400.

FIG. 3 further illustrates multiple illumination sources (e.g., lasers, without limitation) at acute glancing angles with the powder bed 400 and a camera 302, which may be an example of a portion of the sensors 122 of FIG. 1. The illumination sources include a first longitudinal illumination source 304, a second longitudinal illumination source 310, a first lateral illumination source 306, and a second lateral illumination source 308. It should be noted that in some embodiments a greater number or lower number of illumination sources (e.g., one illumination source, two illumination sources, three illumination sources, or greater than four illumination sources) may be used. It is also noted that in some embodiments multiple cameras may be used. The camera 302 is configured to receive scattered illumination 324 that has been scattered by the powder 322 on the powder bed 400 responsive to incident illumination 326 provided by the illumination sources. It is noted that for the sake of simplicity, FIG. 3 only illustrates scattered illumination 324 in a direction toward the camera 302. The scattered illumination 324, however, will be provided in many directions responsive to the incident illumination 326 from the illumination sources. It is also noted that, although not shown, the camera 302 may also receive reflected, refracted, and/or diffracted illumination responsive to the incident illumination 326.

A glancing angle 320 of the incident illumination 326 from each of the illumination sources with respect to the powder bed 400 is acute. In other words, dark field lighting may be used. By way of non-limiting example, the glancing angle 320 of the incident illumination 326 with respect to the powder bed 400 may be less than sixty degrees, less than forty-five degrees, less than thirty degrees, less than twenty degrees, less than ten degrees, or even less than five degrees. A relatively small glancing angle 320 may enable detection of fine features of the powder 322 (e.g., features of the individual particles such as ripples and/or features of a distribution of the individual particles) and or the powder bed 400 (e.g., wavy spread, short spread, bed misalignment, uneven coater blade, misalignment of the re-coater assembly 300, other irregularities, etc.) that may not be detectible based on incident illumination having a relatively larger, perpendicular, or near perpendicular glancing angle (not shown).

The incident illumination 326 from the first longitudinal illumination source 304 and the second longitudinal illumination source 310 may be aligned with the re-coater direction of travel 312. In other words, although the first longitudinal illumination source 304 and the second longitudinal illumination source 310 are configured to point at acute glancing angles to the powder bed 400, the first longitudinal illumination source 304 and the second longitudinal illumination source 310 may be configured to point in alignment with the re-coater direction of travel 312. Also, the incident illumination 326 from the first lateral illumination source 306 and the second lateral illumination source 308 may be perpendicular to the re-coater direction of travel 312. In other words, the first lateral illumination source 306 and the second lateral illumination source 308 may be configured to point perpendicularly to the re-coater direction of travel 312.

In some embodiments the glancing angle 320 of each of the illumination sources with respect to the powder bed 400 may be electrically adjustable. By way of non-limiting example, the control circuitry 600 of FIG. 1 may be configured to control actuators (not shown) such as electric motors to adjust the glancing angle 320 of each of the illumination sources. In some embodiments a height of each of the illumination sources above the powder bed 400 may be electrically adjustable. By way of non-limiting example, the control circuitry 600 of FIG. 1 may be configured to control actuators (not shown) such as electric motors to adjust the height of each of the illumination sources above the powder bed 400. Accordingly, different portions of the powder 322 and/or the powder bed 400 may be highlighted. Also, long exposure of the powder 322 and/or the powder bed 400 to the incident illumination 326 may be used, which may enable capture of information regarding features of the powder 322 and/or the powder bed 400. More detail regarding electrical adjustments in the height and angle of the illumination sources is discussed below with reference to FIG. 4. In some embodiments a power, a frequency (e.g., in the visible and non-visible spectrums), or both of the illumination from each of the illumination sources may also be electrically controllable (e.g., by the control circuitry 600 of FIG. 1).

In operation the illumination sources provide the incident illumination 326 to the powder 322 on the powder bed 400. The illumination sources may also provide the incident illumination 326 to other objects (not shown, e.g., parts to be treated with a laser) on the powder bed 400, and to the powder bed 400 itself. The powder 322, the other objects, and the powder bed 400 may scatter, reflect, refract, and/or diffract the incident illumination 326 to provide the scattered illumination 324. The camera 302 senses a portion of the scattered illumination 324, and provides data corresponding to the captured portion of the scattered illumination 324 (e.g., image data) to control circuitry (e.g., as sensor signals 126 to the control circuitry 600 of FIG. 1). The control circuitry analyzes the data corresponding to the captured portion of the scattered illumination 324 to identify features of the powder 322, the other objects, and/or the powder bed 400. By way of non-limiting example, the control circuitry may identify one or more of the input factors 200 of the material category 202 (FIG. 2) responsive to the data corresponding to the captured portion of the scattered illumination 324. The powder 322 is used to manufacture an object 114 (FIG. 1). The identified features of the powder 322, the other objects, and/or the powder bed 500 are used as input factors 200 (FIG. 1 and FIG. 2) to correlate with manufacturing outcomes 110 (FIG. 1) responsive to manufacturing of the object 114. By way of non-limiting examples, input factors 200 that may identified may include improper powder spread, recoater interference with parts, discoloration due to improper welding, and geometric distortion.

It is noted that a powder bed 400, illumination sources, and camera 302 such as those discussed for FIG. 3 may be used at a material feed (e.g., the material feed 106 of FIG. 1) instead of or in addition to at a material delivery system (e.g., the material delivery system 116 of FIG. 1) to monitor properties of the powder 322 as the powder 322 is fed to a material feed (e.g., the material feed 106 of FIG. 1) of an additive manufacturing apparatus (e.g., the additive manufacturing apparatus 104 of FIG. 11). Accordingly, in such instances input factors 200 regarding the powder 322 may be obtained as the powder 322 is fed to the additive manufacturing apparatus instead of, or in addition to, obtaining of input factors 200 regarding the powder 322 as the powder 322 is delivered from the material feed to the platform (e.g., the platform 108 of FIG. 1)

FIG. 4 is a cross-sectional view of a powder bed 400 of the re-coater assembly 300 of FIG. 3, according to some embodiments. The cross-sectional view of the powder bed 400 is the cross-sectional view taken along the longitudinal cross-section 316 of the powder bed 400 shown in FIG. 3. A bed width 420 of the powder bed 400 may be, by way of non-limiting example, 250 millimeters (mm). FIG. 4 illustrates the powder 322 of FIG. 3 on the powder bed 400. In the example of FIG. 4, a first feature 402, a second feature 404, and a third feature 406 of the powder 322 are illustrated on the powder bed 400. The first feature 402 is closer to the first longitudinal illumination source 304 than the second feature 404 and the third feature 406. Also, the third feature 406 is farther from the first longitudinal illumination source 304 than the first feature 402 and the second feature 404. In the example illustrated in FIG. 4 a feature spacing 422 between powder features (e.g., first feature 402, second feature 404, and third feature 406) may be substantially 150 micrometers and a feature height 424 may be less than 100 micrometers.

The bed width 420, the feature spacing 422, and the feature height 424 may be used to determine appropriate angles and heights for the first longitudinal illumination source 304. For example, the position of the first longitudinal illumination source 304 (e.g., the height of the first longitudinal illumination source 304 above the powder bed 400) may be determined based at least in part by the bed width 420, which may imply a minimum and maximum distance of the first longitudinal illumination source 304 from the features. Also, minimum and maximum glancing angles of the first longitudinal illumination source 304 with respect to the powder bed 400 may be determine based at least in part on the feature height 424 and the feature spacing 422.

For example, FIG. 4 illustrates the first longitudinal illumination source 304 in a first position POS 1. In the first position of the first longitudinal illumination source 304 is located at a first height 414 above the powder bed 400 (e.g., above a top surface of the powder bed 400) and at a first glancing angle 408 with the powder bed 400. At the first position POS 1 the first longitudinal illumination source 304 may be capable of illuminating the first feature 402 of the powder 322. Accordingly, with the first longitudinal illumination source 304 positioned at the first position, a camera (e.g., the camera 302 of FIG. 3) may be expected to detect features that are relatively close to the first longitudinal illumination source 304, such as the first feature 402. FIG. 4 also illustrates the first longitudinal illumination source 304 in a second position POS 2. In the second position the first longitudinal illumination source 304 is located at a second height 416 above the powder bed 400 and at a second glancing angle 410 with the powder bed 400. At the second position POS 2 the first longitudinal illumination source 304 may be capable of illuminating the second feature 404 of the powder 322. FIG. 4 further illustrates the first longitudinal illumination source 304 at a third position POS 3. In the third position POS 3 the first longitudinal illumination source 304 is located at a third height 418 above the powder bed 400 and at a third glancing angle 412 with the powder bed 400. At the third position POS 3 the first longitudinal illumination source 304 may be capable of illuminating the third feature 406.

Since the first longitudinal illumination source 304 is configured to be positioned at various different positions (e.g., heights above the powder bed 400) with various different glancing angles, the first longitudinal illumination source 304 may be used to scan its incident illumination (e.g., the incident illumination 326 of FIG. 3) across the powder 322 on the powder bed 400 from various different heights. Accordingly, a camera (e.g., the camera 302) may obtain scattered illumination (e.g., the scattered illumination 324 of FIG. 3) from the first longitudinal illumination source 304, which may make apparent diverse features of the powder 322 anywhere on the powder bed 400. In some embodiments long exposures during sweep of the illumination sources (e.g., first longitudinal illumination source 304) through multiple angles may be used. Also, Reduction of ambient lighting effects may be accomplished by using strobing (e.g., high-intensity strobing), filters, physical enclosures, or combinations thereof.

Although the discussion of FIG. 4 focuses on the first longitudinal illumination source 304, it will be appreciated that the discussion applies equally to each of the illumination sources (first longitudinal illumination source 304, second longitudinal illumination source 310, first lateral illumination source 306, and second lateral illumination source 308) illustrated in FIG. 3.

As previously mentioned, the illumination sources (e.g., the first longitudinal illumination source 304) may be lasers. Laser line projection may lead to faster detection of properties of the powder 322 than some non-laser illumination sources. Also, laser line projection may accurately detect small features, (e.g., ripples on the surface of powder particles).

FIG. 5 is a block diagram of an additive manufacturing system 500, which is an example of the additive manufacturing system 100 of FIG. 1, according to some embodiments. The additive manufacturing system 500 includes the control circuitry 600, storage 102, input factors 200, manufacturing outcomes 110, additive manufacturing apparatus 104, material feed 106, feedstock material 112, control signals 124, sensors 122, and sensor signals 126 discussed above with reference to FIG. 1. The sensors 122 of FIG. 5, however, include at least one X-ray system 502, and the sensor signals 126 of FIG. 5 include material data 512 regarding the feedstock material 112 from the at least one X-ray system 502.

The X-ray system 502 includes an X-ray emitter 504 configured to generate and emit emitted X-rays 508 toward the feedstock material 112 (e.g., as the feedstock material 112 is fed into the material feed 106, as the feedstock material 112 passes through an X-ray chamber 516 from the material feed 106 to the material delivery system 116, or a combination thereof). The X-ray system 502 also includes an X-ray detector 506 configured to detect returned X-rays 510 returned from the feedstock material 112 responsive to the emitted X-rays 508. The X-ray system 502 is configured to generate the material data 512 responsive to the returned X-rays 510, and provide the material data 512 to the control circuitry 600 in the sensor signals 126.

The material data 512 from the X-ray system 502 may be capable of providing insight to properties of the feedstock material 112 that may not be clear or available from other types of sensors, such as the camera 302 of FIG. 3. Accordingly, the X-ray system 502 may be used instead of or in addition to the camera 302 of FIG. 3 and other sensors of the sensors 122. As specific, non-limiting examples, the material data 512 may be configured to indicate particle size (e.g., the particle size 218 of FIG. 2), humidity (e.g., the humidity 220 of FIG. 2), gas inclusions (e.g., in particles of a powder form of the feedstock material 112), level of hybridization of the feedstock material 112 (e.g., virgin versus previously processed feedstock material 112 such as powder) other information, or combinations thereof. Since feedstock material 112 left over from previous additive manufacturing processes may in some instances be reused, it may be helpful to monitor, using the control circuitry 600, any correlations 128 between the level of hybridization of the feedstock material 112 and manufacturing outcomes 110. The control circuitry 600 may also monitor other correlations 128 between the material data 512 and manufacturing outcomes 110.

The control circuitry 600 is configured to modify operation of the additive manufacturing apparatus 104 based on the identified correlations 128 between the material data 512 and the correlations manufacturing outcomes 110. By way of non-limiting example, if the material data 512 indicates properties of the feedstock material 112 that have been correlated in the correlations 128 to undesirable manufacturing outcomes 110, the control circuitry 106 may control the additive manufacturing apparatus 104 to take corrective action such as to send the feedstock material 112 to a discard 518 rather than to the build chamber 130. As a specific non-limiting example the material delivery system 116 may include a powder handler configured to discard the feedstock material 112 to the discard 518 responsive to a determination that the material data 512 indicates a property of the feedstock material that is correlated in the correlations 128 to an undesirable manufacturing outcome 110.

The feedstock material 112 (e.g., powder) characteristics may have a significant effect on direct metal laser melting (DMLM) and directed energy deposition (DED) built part properties. The use of at least one X-ray system 502 in conjunction with the material feed 106 and/or the material delivery system 116 enables continuous collection of X-ray images of the feedstock material 112 as it enters the material feed 106 and/or as passes through the X-ray chamber 516. A computer program (e.g., computer-readable instructions) deployed at the control circuitry 600 (e.g., which may include Edge computing and/or cloud connectivity) analyzes the X-ray images in real time and monitors characteristics such as powder morphology, particle size, constituents, and impurities. The control circuitry 600 detects out-of-specification material characteristics from the material data 512 and generates real-time notifications indicating the out-of-specification material characteristics. As previously discussed, the control circuitry 106 may also send a signal (e.g., via the control signals 124) to instruct the material delivery system 116 (e.g., the powder handler 514) to discard a portion of the feedstock material 112.

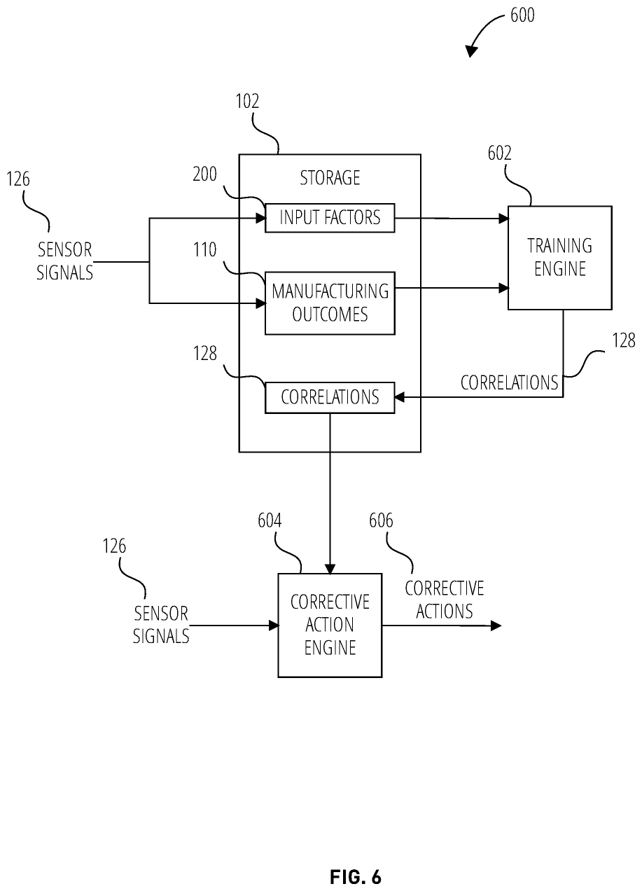

FIG. 6 is a block diagram of the control circuitry 600 of the additive manufacturing system 100 of FIG. 1, according to some embodiments. The control circuitry 600 includes storage 102, a training engine 602, and a corrective action engine 604. As previously discussed, the storage 102 is configured to store input factors 200, manufacturing outcomes 110, and identified statistically significant correlations 128 between the input factors 200 and the manufacturing outcomes 110. The training engine 602 is configured to identify the correlations between the input factors 200 and the manufacturing outcomes 110, and provide the identified correlations 128 to storage 102. The corrective action engine 604 is configured to identify corrective actions 608 that may be taken responsive to sensor signals 126 and based on the identified correlations 128 and to improve manufacturing of an object 114 (FIG. 1).

The training engine 602 is configured to distinguish between statistically significant and coincidental correlations128 between the input factors 200 and the manufacturing outcomes 110. A statistically significant correlation between one or more of the input factors 200 and one or more of the manufacturing outcomes 110 means that the training engine 602 has determined that the correlation is not due to chance or noise in the data. In some embodiments the training engine 602 may be configured to use hypothesis testing to determine the identified correlations 128. For example, the training engine 602 may define a null hypothesis (e.g., defining that no correlation exists) and calculate a probability value estimating the probability that the correlation is due to chance. If the calculated probability value is smaller than a predetermined threshold probability value (e.g., 5%), the training engine 602 may determine that the correlation is due to chance or noise, and is not statistically significant. If, however, the calculated probability is greater than or equal to the predetermined threshold probability value the training engine 602 may generate the identified correlations 128 indicating the identified correlation, and provide the identified correlations 128 to the corrective action engine 604.

The corrective action engine 604 is configured to receive the identified correlations 128, receive sensor signals 126, and determine whether one or more corrective actions 608 should be taken based on the sensor signals 126 and the identified correlations 128. For example, the corrective action engine 604 may be configured to determine whether the manufacturing outcomes 110 corresponding to the identified correlations 128 are desirable, undesirable, or neutral. If the corrective action engine 604 determines that the manufacturing outcomes 110 corresponding to the identified correlations 128 are desirable, the corrective action engine 604 may be configured to cause whichever of the input factors 200 that are identified as correlated to the desirable manufacturing outcomes 110 to be maintained when manifested to be present by the sensor signals 126, introduced when not manifested to be present by the sensor signals 126, or even increased when manifested to be present by the sensor signals 126. If the corrective action engine 604 determines that the manufacturing outcomes 110 corresponding to the identified correlations 128 are not desirable, the corrective action engine 604 may be configured to cause whichever of the input factors 200 that are identified as correlated to the undesirable manufacturing outcomes 110 to be reduced or eliminated when manifested to be present by the sensor signals 126, and avoided or prevented when not manifested to be present by the sensor signals 126. If the corrective action engine 604 determines that the manufacturing outcomes 110 corresponding to the identified correlations 128 are neutral, the corrective action engine 604 may be configured to take no corrective action whether or not the corresponding input factors 200 are manifested to be present by the sensor signals 126.

In some embodiments the corrective action engine 604 may be configured to provide the corrective actions 608 in the form of control signals 124 (FIG. 1) in instances where the corrective actions 608 include automated corrective actions that may be controlled responsive to the control signals 124. By way of non-limiting example, the corrective action engine 604 may be configured to generate control signals 124 configured to control operation of the material feed 106, the laser system 118, the material delivery system 116 (FIG. 1, FIG. 5), other devices, or combinations thereof. In some embodiments the corrective action engine 604 may be configured to provide the corrective actions 608 in the form of messages to a user of the additive manufacturing system 100 (FIG. 1) in instances where the corrective actions 608 include actions involving intervention from the user.

In some embodiments, the training engine 602 may be configured to provide identified correlations 128 in at least substantially real-time as the input factors 200 and/or the manufacturing outcomes 110 are collected in the storage 102 (e.g., via the sensor signals 126). In some such embodiments the corrective action engine 604 may be configured to identify correlations 128 in real time, which may also be used to trigger the corrective actions 608 in at least substantially real-time. By way of non-limiting example, during operation of the additive manufacturing system 100 of FIG. 1 the sensors 122 (FIG. 1) may provide sensor signals 126 indicating undesirable deformation of the object 114 (FIG. 1) (e.g., curling) to the manufacturing outcomes 110 in the storage 102 following provision, by the sensor signals 126 (e.g., from the camera 302 of FIG. 3 and/or from the X-ray detector 506 of FIG. 5), of information related to a specific property of the feedstock material 112. The training engine 602 may be configured to detect a statistically significant correlation, or refer to a previously identified statistically significant correlation, between the undesirable deformation of the object 114 and the specific property of the feedstock material 112, and provide the identified correlations 128 indicating the statistically significant correlation. The corrective action engine 604 may trigger the corrective actions 608 responsive to the sensor signals 126 and the correlations 128. An example of one of the corrective actions 608 that may be triggered may include halting, via the control signals 124, operation of the material feed 106 (FIG. 1) and/or the material delivery system 116 (FIG. 1). Another example of one of the corrective actions 608 that may be triggered may include transmitting a message to a user of the additive manufacturing system 100 indicating the undesirable manufacturing outcomes 110 and the correlated input factors 200 and/or instructions for instructing the user to remedy the undesirable input factors 200 (e.g., replacing the feedstock material 112 with feedstock material 112 that does not have or has less of the undesirable input factors 200).

The identified correlations 128 and the corrective actions 608 may be provided to the storage 102 for future reference. Accordingly, previously identified correlations 128 and corrective actions 608 may be used in addition to currently identified correlations 128 and corrective actions 608. Also, the control circuitry 600 may become better and better trained over time to improve the manufacturing outcomes 110.

The storage 102 may include any device that is configured to electrically store information. In some embodiments the storage 102 may include a volatile data storage device (e.g., random access memory), a non-volatile data storage device (e.g., read only memory), or combinations thereof.

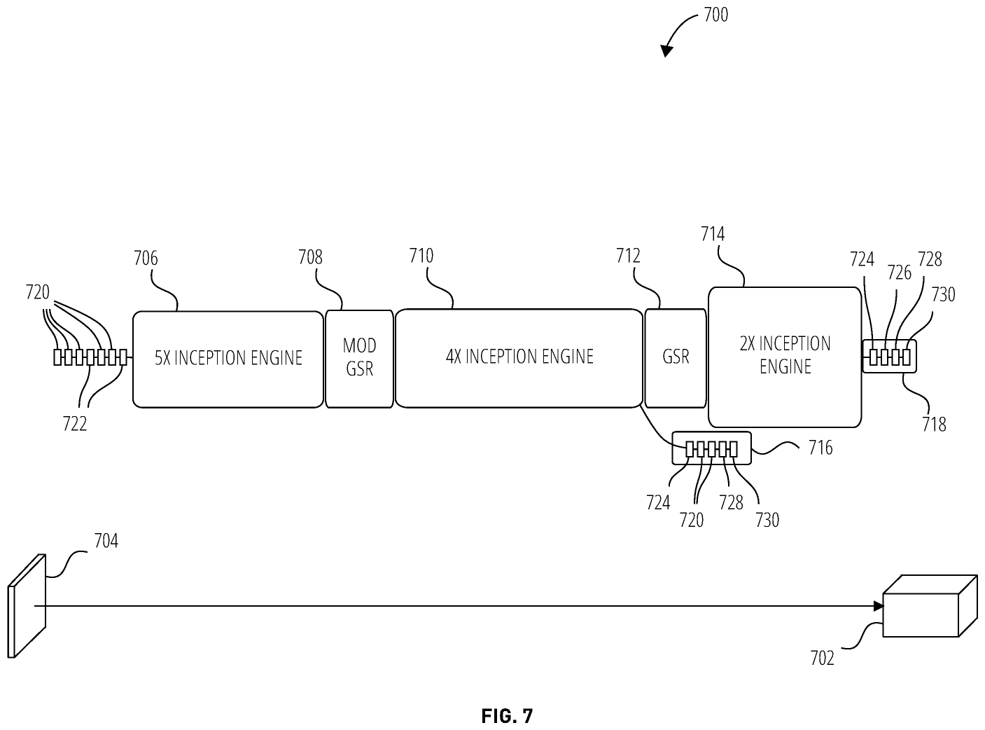

FIG. 7 is a block diagram of an example of a training engine 700, which may be used as the training engine 602 of the control circuitry 600 of FIG. 6, according to some embodiments. The training engine 700 may be specifically designed for processing images (e.g., images of the feedstock material 112 of FIG. 1 captured using the camera 302 of FIG. 3 or the X-ray detector 506 of FIG. 5, images of the object 114 captured by the sensors 122 of FIG. 1, etc.). An input 704 of the training engine 700 may be a 299×299×3 object, and at its output 702 may be an 8×8×2048 object.

The training engine 700 is a neural network. By way of non-limiting example, the training engine 700 may be implemented as an Inceptionv3 neural network, which is an open source convolutional neural network introduced by Google LLC of Mountain View California. The training engine 700 includes a 5× inception engine 706, a modified grid size reduction 708, a 4× inception engine 710, a grid size reduction 712, a 2× inception engine 714, an auxiliary classifier 716, and a final part 718. The training engine 700 is made up of convolution layers 720, maxpool layers 722, AvgPool layers 724, dropout layers 726, fully connected layers 728, softmax layers 730, and concat layers (not shown). At its input the training engine 700 includes five convolution layers 720 and two maxpool layers 722, which are followed by the 5× inception engine 706, the modified grid size reduction 708, the 4× inception engine 710, the grid size reduction 712, the 2× inception engine 714, and the final part 718. The auxiliary classifier 716 extends from the 4× inception engine 710. The auxiliary classifier 716 includes one of the AvgPool layers 724 followed by two of the convolution layers 720, one of the fully connected layers 728, and one of the softmax layers 730. The final part 718 includes one of the AvgPool layers 724 followed by one of the dropout layers 726, one of the fully connected layers 728, and one of the softmax layers 730.

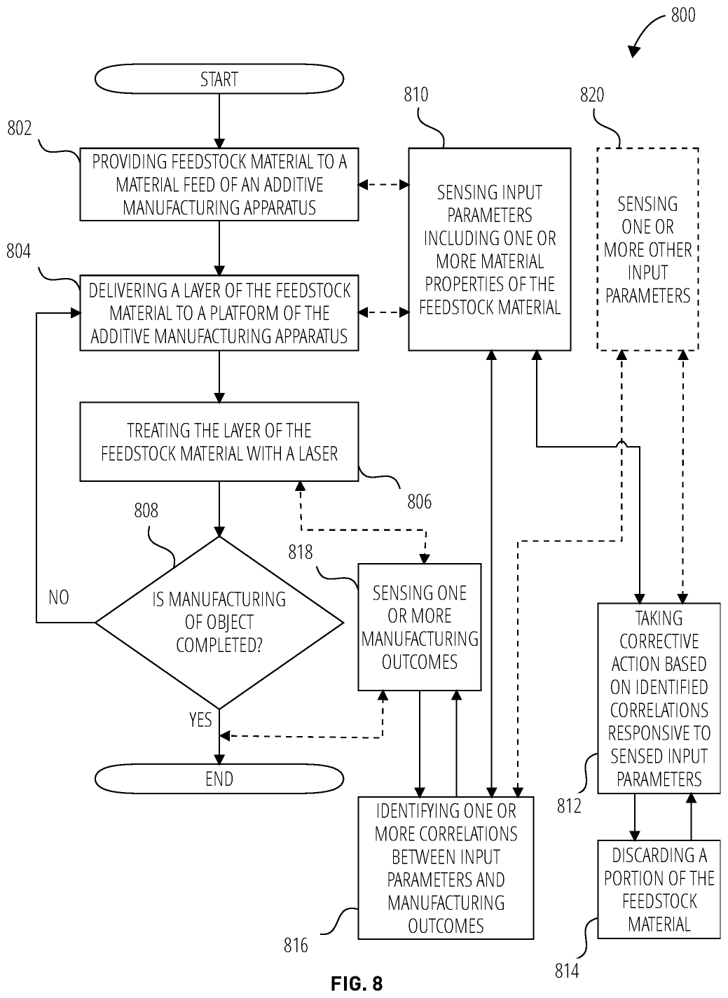

FIG. 8 is a flowchart illustrating a method 800 of operating an additive manufacturing system (e.g., the additive manufacturing system 100 of FIG. 1), according to some embodiments. At operation 802, method 800 includes providing feedstock material to a material feed of an additive manufacturing apparatus. The feedstock material may include powder, wire, filament, or slurry. In some embodiments the feedstock material includes metal, plastic, ceramic, or combinations thereof.

At operation 804, method 800 includes delivering a layer of the feedstock material to a platform of the additive manufacturing apparatus. By way of non-limiting example, delivering a layer of the feedstock material to the platform may include delivering the layer of the feedstock material to the platform using a material delivery system (e.g., the material delivery system 116 of FIG. 1).

At operation 806, method 800 includes treating the layer of the feedstock material with a laser. Treating the layer of the feedstock material with the laser may convert the layer of the feedstock material to a layer of the object to be manufactured.

At decision 808, method 800 includes determining whether manufacturing of an object is completed. If it is determined that manufacturing of the object is not completed, method 800 returns to operation 804. If it is determined that manufacturing of the object is completed, method 800 ends.

At operation 810 method 800 includes sensing input parameters including one or more material properties of the feedstock material. In some embodiments sensing one or more material properties of the feedstock material includes sensing the one or more material properties of the feedstock material using a camera (e.g., camera 302 of FIG. 3) in conjunction with one or more illumination sources (e.g., first longitudinal illumination source 304, first lateral illumination source 306, second lateral illumination source 308, second longitudinal illumination source 310, or combinations thereof, of FIG. 3) pointing at acute angles with a powder bed (e.g., the powder bed 400 of FIG. 3 and FIG. 4). In some embodiments sensing one or more material properties of the feedstock material includes sensing the one or more material properties of the feedstock material using an x-ray system (e.g., the X-ray system 502 of FIG. 5). In some embodiments the one or more material properties of the feedstock material may include one or more material properties from the material category 202 of the input factors 200 of FIG. 1. Operation 810, sensing input parameters including one or more material properties of the feedstock material, may be performed at any point during the method 800. By way of non-limiting examples, operation 810 may be performed during operation 802, operation 804, operation 806, and even after operation 806. A camera may even sense recoating anomalies (e.g., of a feedstock material) after a layer of feedstock material is delivered (e.g., in operation 804) or during a melting/welding process after a layer is treated with a laser (e.g., operation 806).

At operation 816, method 800 includes sensing one or more other input parameters. By way of non-limiting example the one or more other input parameters may include any one or more of the input factors 200 of FIG. 2. Operation 816, sensing one or more other input parameters, may occur at any point of time throughout the method 800. Sensing one or more other input parameters may include receiving sensor signals (e.g., the sensor signals 126 of FIG. 1) from sensors (e.g., the sensors 122 of FIG. 1).

At operation 814, method 800 includes sensing one or more manufacturing outcomes. Sensing the one or more manufacturing outcomes may occur before it is determined that manufacturing of the object is completed at decision 808 (e.g., layer-by-layer manufacturing outcomes to be correlated to layer-by-layer input parameters), after it is determined that manufacturing of the object is completed at decision 808, or both. By way of non-limiting example, the additive manufacturing apparatus may include one or more image sensors (e.g., cameras) configured to capture images of the object being manufactured during manufacturing and/or after completion of manufacturing. The one or more image sensors may provide sensor signals (e.g., the sensor signals 126 of FIG. 1) including the captured images.

At operation 812, method 800 includes identifying one or more correlations between the input parameters and the manufacturing outcomes. The identified correlations between the input parameters and the manufacturing outcomes may include correlations between the material properties, as sensed in operation 810, and the manufacturing outcomes, as sensed in operation 814. Also, in some embodiments the identified correlations between the input parameters and the manufacturing outcomes may include correlations between the input parameters, as sensed in operation 816, and the manufacturing outcomes, as sensed in operation 814.

At operation 818, method 800 includes taking corrective action based on identified correlations responsive to sensed input parameters. By way of non-limiting example, detrimental input parameters corresponding to undesirable manufacturing outcomes may be reduced, avoided, or eliminated. As a specific non-limiting example, taking corrective action based on identified correlations responsive to sensed input parameters may include, at operation 820, discarding (e.g., using the powder handler 514 of FIG. 5) a portion of the feedstock material (e.g., powder) based on an identified correlation (e.g., a previously identified or a real-time identified correlation) between a particular material property and an undesirable manufacturing outcome responsive to the input parameters (e.g., sensed in real time) indicating the particular material property. Also by way of non-limiting example, beneficial input parameters corresponding to desirable manufacturing outcomes may be increased, introduced, or maintained. In some embodiments taking corrective action may occur in at least substantially real-time as sensing input parameters (operation 810, operation 816) and sensing manufacturing outcomes (operation 814) during manufacturing of the object occurs. In some embodiments taking corrective action may include taking corrective action during manufacturing of a subsequent object. In some embodiments operation 818, taking corrective action, may be performed layer by layer, e.g., after each layer of feedstock material that is delivered (operation 804) and treated (operation 806) with a laser.

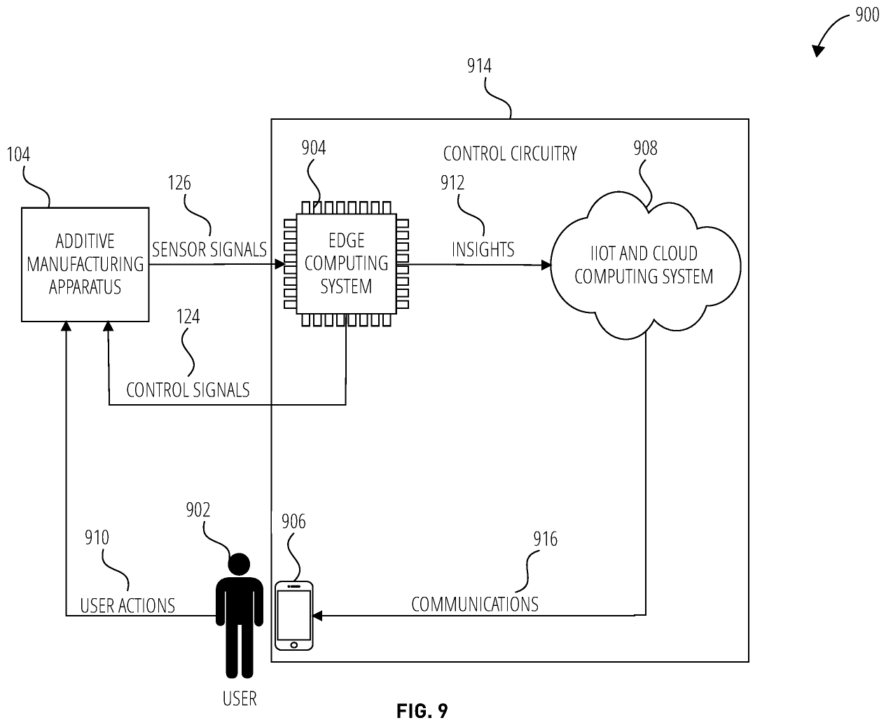

FIG. 9 is a block diagram of a network-based additive manufacturing system 900, according to some embodiments. The network-based additive manufacturing system 900 is similar to the additive manufacturing system 100 of FIG. 1. For example, the network-based additive manufacturing system 900 includes the additive manufacturing apparatus 104 of FIG. 1. The network-based additive manufacturing system 900 also includes control circuitry 914, which is an example of the control circuitry 600 of FIG. 1 and FIG. 6. The control circuitry 914 is implemented using a distributed computing architecture. For example, the control circuitry 914 includes an edge computing system 904, an industrial internet of things (HOT) and cloud computing system 908, and a user device 906.

The edge computing system 904 may be located locally to the additive manufacturing apparatus 104 to enable the edge computing system 904 to participate in real-time interactions with the additive manufacturing apparatus 104. The edge computing system 904 is configured to receive sensor signals 126 from the additive manufacturing apparatus 104, and provide control signals 124 to the additive manufacturing apparatus 104. The sensor signals 126 and the control signals 124 may be similar as discussed above with reference to FIG. 1. In some embodiments the control signals 124 include real-time control signals. The control signals 124 be configured to control certain operations of the additive manufacturing apparatus 104, and may also provide for corrective action triggered by the control circuitry 914. The edge computing system 904 is configured to provide insights 912 to the IIOT and cloud computing system 908. The insights 912 may include information related to the sensor signals 126 and/or the control signals 124.

The IIOT and cloud computing system 908 is configured to receive the insights 912 and generate communications 916 to be transmitted to the user device 906 responsive to the insights 912. For example, the communications 916 may include instructions for a user 902 of the additive manufacturing apparatus 104 to perform user actions 910 (e.g., manual tasks) for operation of the additive manufacturing apparatus 104. These user actions 910 may include corrective actions that involve manual intervention. Also, these user actions 910 may relate to monitoring, utilization, and condition-based maintenance of the additive manufacturing apparatus 104. By way of non-limiting example, the communications 916 may include email messages. Also by way of non-limiting example the communications 916 may include text messages.

The user device 906 may include any device that is capable of communication with the IIOT and cloud computing system 908. By way of non-limiting example, the user device 906 may include a cellular telephone device (e.g., a smartphone), a tablet computer, a personal computer (PC), or other device configured to receive the communications 916 from the IIOT and cloud computing system 908.

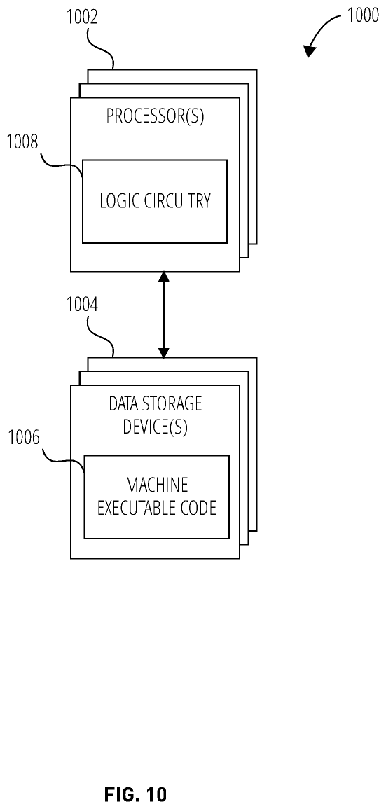

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 10 illustrates non-limiting examples of implementations of functional elements disclosed herein. In some embodiments, some or all portions of the functional elements disclosed herein may be performed by hardware specially configured for carrying out the functional elements.

FIG. 10 is a block diagram of circuitry 1000 that, in some embodiments, may be used to implement various functions, operations, acts, processes, and/or methods disclosed herein. The circuitry 1000 includes one or more processors 1002 (sometimes referred to herein as “processors 1002”) operably coupled to one or more data storage devices (sometimes referred to herein as “storage 1004”). The storage 1004 includes machine executable code 1006 stored thereon and the processors 1002 include logic circuitry 1008. The machine executable code 1006 includes information describing functional elements that may be implemented by (e.g., performed by) the logic circuitry 1008. The logic circuitry 1008 is adapted to implement (e.g., perform) the functional elements described by the machine executable code 1006. The circuitry 1000, when executing the functional elements described by the machine executable code 1006, should be considered as special purpose hardware configured for carrying out functional elements disclosed herein. In some embodiments the processors 1002 may be configured to perform the functional elements described by the machine executable code 1006 sequentially, concurrently (e.g., on one or more different hardware platforms), or in one or more parallel process streams.

When implemented by logic circuitry 1008 of the processors 1002, the machine executable code 1006 is configured to adapt the processors 1002 to perform operations of embodiments disclosed herein. For example, the machine executable code 1006 may be configured to adapt the processors 1002 to perform at least a portion or a totality of the method 800 of FIG. 8. As another example, the machine executable code 1006 may be configured to adapt the processors 1002 to perform at least a portion or a totality of the operations discussed for the control circuitry 600 of FIG. 1, FIG. 5, and FIG. 6, the training engine 602 of FIG. 6, the corrective action engine 604 of FIG. 6, the training engine 700 of FIG. 7, the edge computing system 904 of FIG. 9, the HOT and cloud computing system 908 of FIG. 9, and/or the user device 906 of FIG. 9. As a specific, non-limiting example, the machine executable code 1006 may be configured to adapt the processors 1002 to identify statistically significant correlations between input factors and manufacturing outcomes in additive manufacturing systems. As another specific, non-limiting example, the machine executable code 1006 may be configured to adapt the processors 1002 to trigger corrective action based on identified correlations between input factors and manufacturing outcomes in additive manufacturing systems responsive to detections of corresponding input factors.

The processors 1002 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine executable code 1006 (e.g., software code, firmware code, hardware descriptions) related to embodiments of the present disclosure. It is noted that a general-purpose processor (may also be referred to herein as a host processor or simply a host) may be a microprocessor, but in the alternative, the processors 1002 may include any conventional processor, controller, microcontroller, or state machine. The processors 1002 may also be implemented as a combination of computing devices, such as a combination of a DSP and a microprocessor, a plurality of microprocessors, one or more microprocessors in conjunction with a DSP core, or any other such configuration.

In some embodiments the storage 1004 includes volatile data storage (e.g., random-access memory (RAM)), non-volatile data storage (e.g., Flash memory, a hard disc drive, a solid state drive, erasable programmable read-only memory (EPROM), etc.). In some embodiments the processors 1002 and the storage 1004 may be implemented into a single device (e.g., a semiconductor device product, a system on chip (SOC), etc.). In some embodiments the processors 1002 and the storage 1004 may be implemented into separate devices.

In some embodiments the machine executable code 1006 may include computer-readable instructions (e.g., software code, firmware code). By way of non-limiting example, the computer-readable instructions may be stored by the storage 1004, accessed directly by the processors 1002, and executed by the processors 1002 using at least the logic circuitry 1008. Also by way of non-limiting example, the computer-readable instructions may be stored on the storage 1004, transferred to a memory device (not shown) for execution, and executed by the processors 1002 using at least the logic circuitry 1008. Accordingly, in some embodiments the logic circuitry 1008 includes electrically configurable logic circuitry 1008.

In some embodiments the machine executable code 1006 may describe hardware (e.g., circuitry) to be implemented in the logic circuitry 1008 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1008 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine executable code 1006 may include an HDL, an RTL, a GL description, a mask level description, other hardware description, or any combination thereof.

In embodiments where the machine executable code 1006 includes a hardware description (at any level of abstraction), a system (not shown, but including the storage 1004) may be configured to implement the hardware description described by the machine executable code 1006. By way of non-limiting example, the processors 1002 may include a programmable logic device (e.g., an FPGA or a PLC) and the logic circuitry 1008 may be electrically controlled to implement circuitry corresponding to the hardware description into the logic circuitry 1008. Also by way of non-limiting example, the logic circuitry 1008 may include hard-wired logic manufactured by a manufacturing system (not shown, but including the storage 1004) according to the hardware description of the machine executable code 1006.

Regardless of whether the machine executable code 1006 includes computer-readable instructions or a hardware description, the logic circuitry 1008 is adapted to perform the functional elements described by the machine executable code 1006 when implementing the functional elements of the machine executable code 1006. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. An additive manufacturing system, comprising:
an additive manufacturing apparatus including a material feed configured to receive feedstock material to be used in additive manufacturing of an object;
an X-ray system configured to monitor the feedstock material, the X-ray system further configured to provide material data corresponding to the feedstock material; and
control circuitry configured to:
extract one or more feedstock properties from the material data; and
correlate the one or more feedstock properties with one or more manufacturing outcomes responsive to manufacturing the object.

2. The additive manufacturing system of claim 1, wherein the feedstock material includes a powder, and the one or more feedstock properties comprise at least one of a particle size, a humidity of the powder, an indicator of gas inclusions of particles of the powder, and a level of hybridization of the powder.

3. The additive manufacturing system of claim 1, wherein the control circuitry is configured to implement a machine learning system configured to correlate multiple different input factors with the one or more manufacturing outcomes responsive to manufacturing the object.

4. The additive manufacturing system of claim 3, wherein the machine learning system comprises a neural network system.

5. The additive manufacturing system of claim 3, wherein the multiple different input factors comprise one of the material data and process parameters.

6. The additive manufacturing system of claim 1, wherein the one or more manufacturing outcomes comprise mechanical properties of the object.

7. The additive manufacturing system of claim 1, wherein the control circuitry is further configured to correlate the one or more powder characteristics with the one or more manufacturing outcomes in at least substantially real-time as the powder is fed to the material feed.

8. The additive manufacturing system of claim 1, wherein the control circuitry is further configured to trigger one or more corrective actions responsive to a detection of a feedstock property correlated to an unfavorable manufacturing outcome based on an identified correlation between the one or more feedstock properties and the one or more manufacturing outcomes.

9. The additive manufacturing system of claim 8, wherein the one or more corrective actions comprise a discard of at least a portion of the feedstock material.

10. An additive manufacturing system, comprising:
an additive manufacturing apparatus configured to manufacture an object from a feedstock material using additive manufacturing, the additive manufacturing apparatus including a feedstock material bed configured to carry the feedstock material;
one or more illumination sources configured to illuminate the feedstock material bed and the feedstock material carried by the material bed, each of the one or more illumination sources configured to point at a glancing angle with the feedstock material bed of less than sixty degrees;
one or more illumination detectors configured to detect received illumination responsive to the illumination from the one or more illumination sources; and
control circuitry operably coupled to the one more illumination detectors, the control circuitry configured to:
identify one or more input parameters based on the received illumination; and
correlate the one or more input parameters with manufacturing outcomes of the object.

11. The additive manufacturing system of claim 10, wherein the additive manufacturing apparatus further comprises a material delivery system configured to deliver the feedstock material from a material feed of the additive manufacturing apparatus to a platform upon which the object is to be manufactured, the material delivery system comprising the feedstock material bed.

12. The additive manufacturing system of claim 11, wherein the material delivery system comprises a re-coater assembly.

13. The additive manufacturing system of claim 12, wherein at least one of the one or more illumination sources comprises a lateral light source that is configured to point in a pointing direction that is at least substantially perpendicular to a direction of travel of the re-coater assembly.

14. The additive manufacturing system of claim 12, wherein at least one of the one or more illumination sources comprises a longitudinal illumination source configured to point in a pointing direction that is aligned with a direction of travel of the re-coater assembly.

15. The additive manufacturing system of claim 10, wherein the feedstock material bed is configured to provide the feedstock material to a material feed of the additive manufacturing apparatus.

16. The additive manufacturing system of claim 10, wherein the glancing angle that each of the one or more illumination sources is configured to point in is electrically controllable by the control circuitry.

17. The additive manufacturing system of claim 10, wherein each of the one or more illumination sources is configured to point at the feedstock material carried by the feedstock material bed at a glancing angle of less than forty-five degrees with the feedstock material bed.

18. The additive manufacturing system of claim 10, wherein a position of each of the one or more illumination sources relative to a position of the feedstock material bed is electrically controllable by the control circuitry.

19. The additive manufacturing system of claim 10, wherein the one or more identified input parameters comprise at least one of a particle size, a particle distribution, a flowability, a humidity, and a composition of the feedstock material.

20. The additive manufacturing system of claim 10, wherein the manufacturing outcomes comprise a degree of curling of material of the object.
